(19) United States
(12) Patent Application Publication
(10) Pub. No.: US 2025/0380289 A1
(43) Pub. Date: Dec. 11, 2025

(54) TECHNIQUES FOR IMPROVED RADIO PERFORMANCE USING DYNAMIC COEXISTENCE

(71) Applicant: Apple Inc., Cupertino, CA (US)

(72) Inventors: Lynn E. Greiner, Santa Clara, CA (US); Rohit Sharma, San Jose, CA (US); Neeraj Poojary, San Rafael, CA (US); Camille Chen, Cupertino, CA (US); Imran Latif, Pleasanton, CA (US)

(73) Assignee: Apple Inc., Cupertino, CA (US)

(21) Appl. No.: 18/898,411

(22) Filed: Sep. 26, 2024

Related U.S. Application Data
(60) Provisional application No. 63/657,451, filed on Jun. 7, 2024.

(51) Int. Cl. H04W 72/542; H04B 17/318; H04W 88/06

(52) U.S. Cl. CPC H04W 72/542; H04B 17/318; H04W 88/06

(57) ABSTRACT

Techniques are disclosed for a dynamic coexistence policy for operating a plurality of radios using a plurality of antennas of a user device. The user device can configure a plurality of radios of the user device to operate in a first diversity mode state of a plurality of diversity mode states. The plurality of radios can be operable to communicate using one or more of a plurality of antennas of the user device. While in the first diversity mode state, the user device can determine whether a first radio signal strength of a first radio of the plurality of radios is below a first radio signal strength threshold and configure the plurality of radios to operate in a second diversity mode state of the plurality of diversity mode states.

### CROSS-REFERENCES TO OTHER APPLICATIONS

This application claims priority to U.S. Provisional Application No. 63/657,451, for “TECHNIQUES FOR IMPROVED RADIO PERFORMANCE USING DYNAMIC COEXISTENCE” filed on Jun. 7, 2024, and is related to U.S. patent application Ser. No. XX/XXX,XXX, Attorney Docket No. 090911-P67596US2-1468517, entitled “TECHNIQUES FOR IMPROVED RADIO PERFORMANCE USING DYNAMIC COEXISTENCE,” and filed on the same day, which are herein incorporated by reference in their entirety for all purposes.

### BACKGROUND

User devices can include multiple antennas for use with radios for Bluetooth, Wi-Fi, and other wireless communication technologies. The user devices can include handheld devices like tablets in which the antennas can be positioned at the periphery to improve the signal for the radios. Tablet devices have also increased in functionality, allowing them to be used for professional computing tasks that can use high data rates over the radios and that were previously limited to laptop and desktop computers. Because users can grip devices like tablets in a variety of ways, a user's hands may cover one or more of the antennas, causing attenuation of a signal produced or received at those antennas.

To avoid attenuation due to a user's hands covering the antennas, some user devices can include additional antennas positioned to avoid typical grip locations. Configuring multiple radios to transmit and receive on multiple antennas can be challenging.

### SUMMARY

Embodiments of the present disclosure relate to wireless coexistence for user device radios. More particularly, embodiments of the present disclosure provide methods, user devices, and computer-readable media that can configure multiple device radios to operate using a plurality of antennas based on the orientation of the user device. By way of a non-limiting example, a tablet device can include a Bluetooth radio or a Thread radio (in the 2.4 GHz band) and one or more Wi-Fi radios (in the 2.4 GHz band, the 5 GHz band, and/or the 6 GHz band) to support wireless communication between the tablet and, for example, peripheral devices, a wireless network, etc. The tablet can include two primary antennas positioned at two corners of the device chassis, and a third antenna positioned along an edge of the device chassis. The Bluetooth and Wi-Fi radios can be configured to use the primary radios according to a coexistence policy. If the tablet is held in an orientation in which the user's hands cover one or both of the primary antennas at the corners, the tablet can enter a diversity mode in which the selection of the third antenna is determined by the state of the diversity mode. Each radio can continue to select between the available antennas according to their coexistence policy, and the state of the diversity mode can be selected based on the measured signal strength of the radios at one or more of the plurality of antennas.

One embodiment is directed to a method performed by a user device to configure a plurality of radios to operate in diversity mode states using a plurality of antennas of the user device. The method can include receiving an indication that the user device has a physical configuration relative to the plurality of antennas positioned within the user device and, responsive to the indication, configuring the plurality of radios of the user device to operate in a first diversity mode state of a plurality of diversity mode states. The plurality of radios can be operable to transmit and receive using one or more of the plurality of antennas. The method can also include measuring a signal strength for a first radio of the plurality of radios. Measuring the signal strength can occur while in the first diversity mode state. The method can also include determining whether the signal strength of the first radio falls below a signal strength threshold corresponding to the first radio and, in accordance with the signal strength falling below the signal strength threshold, configuring the plurality of radios to operate in a second diversity mode state of the plurality of diversity mode states.

Another embodiment is directed to a user device that includes a radio controller configured to control a plurality of radios, a plurality of antennas communicatively connected to the radio controller, one or more processors and one or more memories storing instructions that, when executed by the one or more processors, cause the user device to perform the method described above.

Still another embodiment is directed to a non-transitory computer-readable medium storing computer-executable instructions that, when executed by one or more processors of a user device, cause the user device to perform the method described above.

### BRIEF DESCRIPTION OF THE DRAWINGS

FIG. 1 illustrates a simplified flow chart and block diagram of a technique to configure radios of a user device to operate in one or more diversity mode states using a plurality of antennas of the user device, according to some embodiments.

FIG. 2 illustrates an example simplified architecture of a radio controller communicatively connected to a plurality of antennas of a user device, according to some embodiments.

FIG. 3 illustrates an example user device including a plurality of antennas positioned around a periphery of the user device, according to some embodiments.

FIG. 4A illustrates an example user device held in an inverted orientation with a user's hand covering a second antenna of a plurality of antennas of the user device, according to some embodiments.

FIG. 4B illustrates the user device of FIG. 4A held in the inverted orientation with a user's hand covering a first antenna of the plurality of antennas of the user device, according to some embodiments.

FIG. 4C illustrates the user device of FIG. 4A held in the inverted orientation with the user's hands covering both the first antenna and the second antenna of the user device, according to some embodiments.

FIG. 5 illustrates a state diagram of the plurality of diversity mode states for configuring the radios of the user device using a plurality of antennas, according to some embodiments.

FIG. 6 illustrates an example user device executing a device location application when operating in one of a plurality of diversity mode states, according to some embodiments.

FIG. 7 illustrates an example architecture of a user device that can implement techniques for operating in a plurality of diversity mode states, according to some embodiments.

FIG. 8 illustrates an example process for configuring a plurality of radios to operate with one or more of a plurality of antennas in one or more of a plurality of diversity mode states, according to some embodiments.

### DETAILED DESCRIPTION

In the following description, various examples will be described. For purposes of explanation, specific configurations and details are set forth in order to provide a thorough understanding of the examples. However, it will also be apparent to one skilled in the art that the examples may be practiced without the specific details. Furthermore, well-known features may be omitted or simplified in order not to obscure the example being described.

Examples of the present disclosure are directed to, among other things, methods, devices, and computer-readable media that can enable a user device to configure multiple wireless communication radios to use a plurality of antennas according to an antenna coexistence policy. In particular, modern user devices like smartphones and tablet computers incorporate a variety of wireless communication technologies, including Bluetooth and Wi-Fi, which can operate in various frequency bands. To accommodate multiple radios that can operate in overlapping bands, user devices typically include multiple antennas to transmit and receive over the operating bands of the radios. The user devices, via a radio controller and associated software, can configure the radios to operate in a way that allows for both the sharing of available channels in the operating bands (to prevent conflicts and interferences among the different radios) and the selection of different antennas from which to transmit and receive. The selection of antennas is typically accomplished by a diversity algorithm that is configured based on parameters specific to a particular radio (e.g., carrier frequency, transmit/receive power thresholds and limits, etc.). In this way, multiple radios can operate simultaneously (or nearly simultaneously) in a hybrid mode without having to operate using a duplexing mode like time division duplexing (TDD). The hybrid operating mode using the diversity algorithm allows for greater data throughput for each radio. The antennas are typically placed near the outer edge of the user device chassis to improve the signal strength.

As the use cases for modern user devices has evolved, the physical configuration of the user devices has changed to improve both the user experience and the technical functionality of the device communication capabilities. For example, handheld tablet devices are now commonly used for professional tasks including video conferencing while simultaneously supporting wireless peripheral devices like styluses and keyboards. The development of detachable keyboards for use with the tablet devices led to the device antennas being placed near the corners of the device chasses. These detachable keyboards can often act like a device cover, wrapping around portions of the device and potentially blocking one or more of the radio antennas. By moving the antennas to the corners, the radio performance can be improved when the cover is in place. However, users can still hold the tablets at the corners in various orientations, covering one or more of the antennas and potentially degrading the radio signals.

To avoid signal degradation, an additional “diversity” antenna can be included in the user devices and positioned so that a user is unlikely to cover all of the antennas during use. However, the additional antenna can complicate conventional antenna diversity policies implemented on the user device that determine how each antenna is used by the various radios. To accommodate the additional antenna, the techniques described herein implement a coexistence diversity mode having multiple operating states for the radios based on the physical configuration (e.g., particular orientation, clamshell configuration/clamshell mode) of the user device and measured signal strengths of the radios. As a user holds the user device in various orientations and with hands in different positions, the user device can measure the signal strengths of the radios and switch from one diversity mode state to another. Each diversity mode state can configure the device radios to operate over different combinations of the antennas. In this way, the user device can select from among the available antennas that provide the best signal for each radio.

As a particular example, a user device (e.g., a tablet device) can include three antennas used when operating two radios. Two of the antennas may be positioned near the corners of the user device chassis, while the third antenna may be positioned near an edge of the user device chassis. A first radio may be a Bluetooth radio operating at 2.4 GHz. A second radio may be a Wi-Fi radio operating at 2.4 GHz and/or 5 GHz. Both radios may be implemented by a radio controller that is capable of transmitting the appropriate radio signal for each radio from the two corner antennas according to an antenna diversity algorithm specific to each radio. When the user device detects that it is being held in a particular orientation (e.g., inverted), the user device can configure the two radios to operate in a diversity mode having several states. Each state of the diversity mode can be entered based on the measured signal strength of one or more of the radios. For example, the user device can measure the received signal strength indicator (RSSI) of the Wi-Fi radio received at one of the corner antennas. If the RSSI falls below a threshold, then the user device can switch to a diversity mode state in which the third antenna is selected for use by both the Bluetooth and Wi-Fi radios instead of the corner antenna having the attenuated signal. While in this diversity mode state, each radio can continue to rely on its specific antenna diversity algorithm to select between the other corner antenna and the third antenna. The user device can continue to measure the RSSIs for each radio (e.g., at specific intervals) and switch to the diversity mode state that provides an improved antenna selection from among the three antennas. In addition, because the Bluetooth radio may be used to aid in precise location determination of connected peripheral devices, the user device can detect when a location detection application is executing on the user device and enter a diversity mode state that selects the specific antenna that provides the best signal strength for the Bluetooth radio. When the location detection application terminates, the user device can return to the previous diversity mode state.

In addition to entering the diversity mode based on detecting a particular orientation of the user device, the user device can also enter the diversity mode when it detects that it is being used in a “clamshell” mode (also referred to herein as clamshell configuration). Because tablet devices have substantially increased their computing functionality in recent years, many users may connect their tablet devices to external peripherals like keyboards and monitors, using the tablet to drive a computing experience similar to a workstation connected to a laptop with its lid closed (e.g., in clamshell mode/clamshell configuration). As in the case of a laptop computer in clamshell mode, a tablet device can be used with external peripherals with the tablet device's cover in place. For example, the tablet device can have a cover that wraps around the front, back, and one or more edges of the tablet device. The cover may occlude one or more of the antennas of the user device. When the user device detects that it is being used in clamshell mode, the user device can enter the diversity mode and change states based on the measured signal strength of the radios at the various antennas.

The examples described herein provide a number of technical improvements to user devices having multiple radios operating on shared antennas and overlapping frequency bands. Including a diversity antenna in a user device allows the radios of the user device to operate with improved signal for a greater number of handling positions and orientations. If a user's hands cover one or more of the antennas, the radios can be configured to use the diversity antenna to transmit and receive. Moreover, implementing a diversity mode can allow the multiple radios to operate using their specific antenna diversity algorithms in a hybrid state without reconfiguring the radios separately. The diversity mode directs each radio to select the diversity antenna according to its diversity algorithm when one of the other antennas is covered by the user's hand, thereby avoiding signal degradation if a radio's diversity algorithm naively selects the covered antenna. In addition, the diversity mode allows for the use of device location features that rely on at least one of the user device radios. Regardless of device orientation and the position of the user's hands, the user device can configure the location detection radio to select the best antenna, including the diversity antenna, for use when performing device location operations.

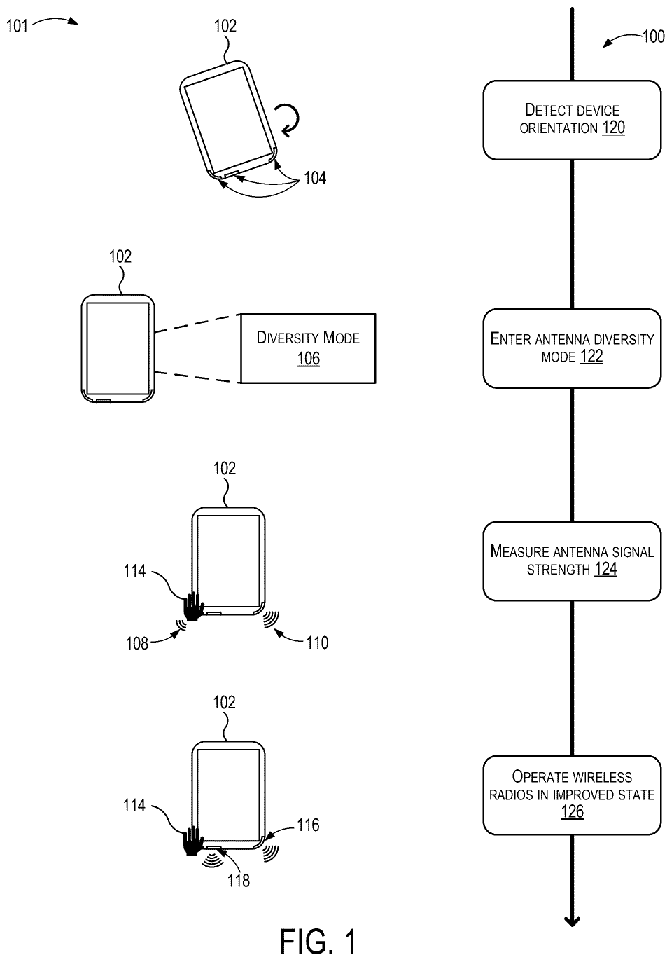

Turning now to the figures, FIG. 1 illustrates a simplified flow chart of an example process 100 and block diagram 101 of a technique to configure radios of a user device 102 to operate in one or more diversity mode states using a plurality of antennas 104 of the user device 102, according to some embodiments. The user device 102 may be an example of a computing device like a smartphone, laptop computer, or, in particular embodiments, a tablet computer that is equipped with more than one antennas used for transmission and reception of signals for one or more radios. The user device 102 is illustrated as a handheld tablet computer.

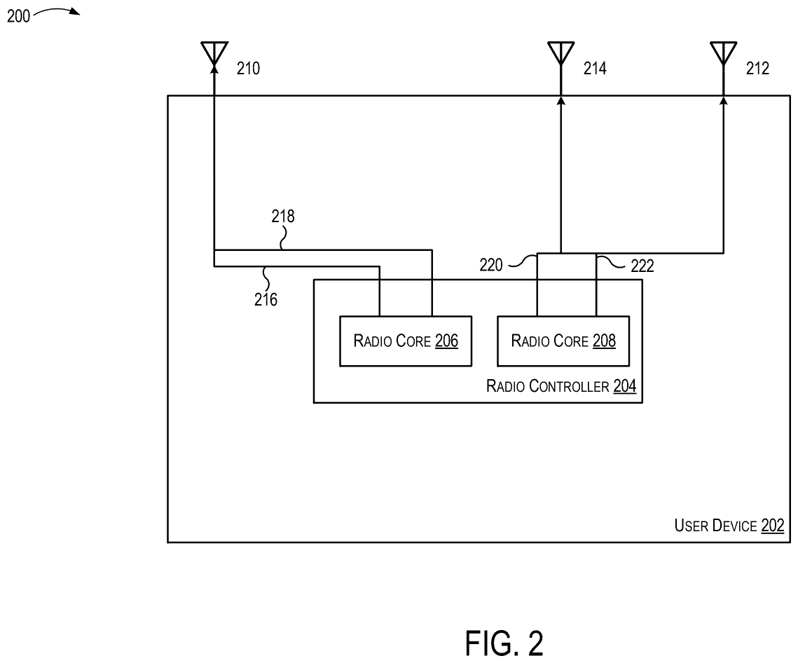

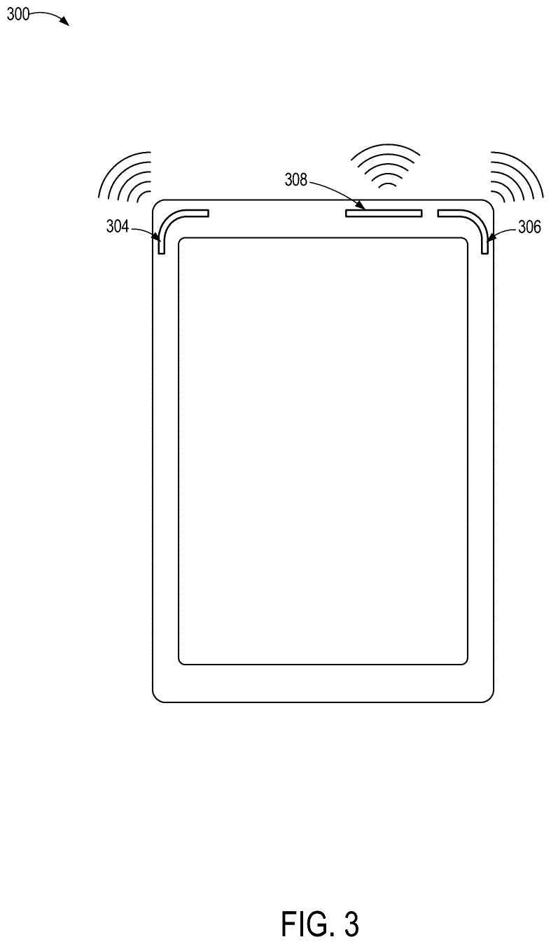

The user device 102 may include a plurality of antennas 104. As depicted in FIG. 1, the plurality of antennas 104 includes two antennas positioned near adjacent corners of the user device 102 and a third antenna positioned near an edge of the user device 102 between the other two antennas. In some examples, the plurality of antennas 104 may be positioned at other locations within the user device 102. For example, the two corner antennas of the plurality of antennas 104 may be positioned at opposite corners or the third antenna may be positioned near an edge of the user device 102 opposite the two corner antennas. Additional details about the plurality of antennas 104 are described below with respect to FIGS. 2 and 3.

The user device 102 can include one or more radios that can use the plurality of antennas 104. For example, the user device 102 can have a Bluetooth radio (operating in the 2.4 GHz band and/or the 5 GHz band) and one or more Wi-Fi radios (operating in the 2.4 GHz band, the 5 GHz band, and/or the 6 GHz band). Each radio can be configured to transmit and/or receive using one or more of the plurality of antennas 104. For example, the two corner antennas depicted for user device 102 may be usable by both the Bluetooth radio (e.g., at the 2.4 GHz band) and the Wi-Fi radio (e.g., at the 2.4 GHz band) to transmit and/or receive communication signals. A radio can implement a coexistence policy that allows for hybrid operations in which the radio can operate simultaneously (or nearly simultaneously or concurrently) with another radio in the device by selecting which of the available antennas are used for the respective radios to avoid conflicts when transmitting and/or receiving signals, without operating strictly in a duplex mode (e.g., time division duplex mode). As described herein, the user device 102 can implement a diversity mode that extends the operation of the two radios to use a third antenna to remain in the hybrid operation mode in a greater number of orientations and/or user hand positions.

The user device 102 can also include one or more orientation sensors (not shown) that allow the user device 102 to determine its orientation. For example, an orientation sensor can be an accelerometer or solid state gyroscope and/or combination of these components that can determine the rotation and orientation of the user device 102. The user device 102 can use the orientation sensor(s) to determine when the user device 102 is in an inverted position.

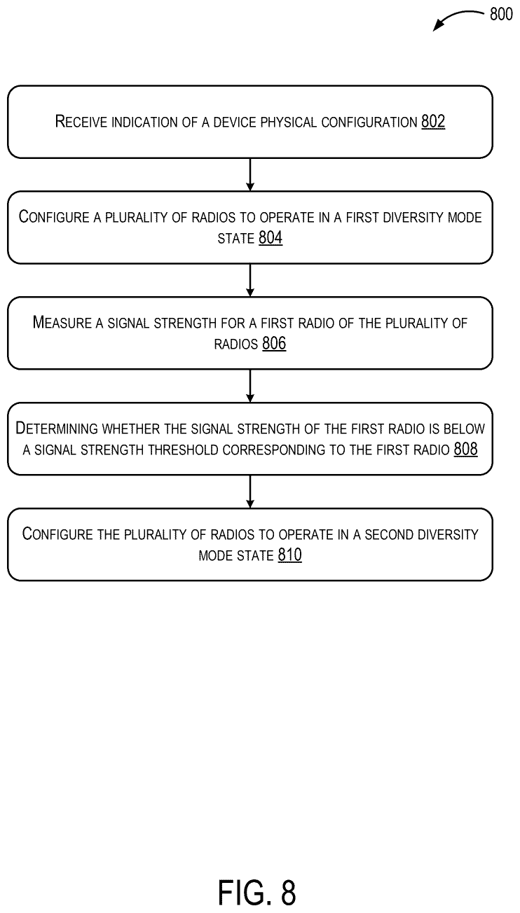

The process 100, and any other process described herein (e.g., process 800 of FIG. 8) are illustrated as logical flow diagrams, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

The process 100 can begin at block 120 with the user device 102 detecting an orientation of the user device 102. As described briefly above, the user device 102 can include one or more orientation sensors that can determine if the user device 102 has been rotated or otherwise positioned into a particular orientation. With reference to the plurality of antennas 104, the user device 102 can determine that the user device 102 is “inverted” such that the plurality of antennas 104 is positioned at, or adjacent to, the bottom of the user device 102 with respect to a user holding the user device 102 vertically (e.g., an inverted portrait orientation). Typically, a user can hold the user device 102 such that the plurality of antennas 104 are positioned at, or adjacent to, the “top” of the user device 102 in the vertical orientation (e.g., a portrait orientation). However, tablet devices and smartphones may be held in various orientations including portrait, landscape, and inverted orientations. Since the plurality of antennas 104 can be fixed within the chassis of the user device 102, the orientation of the user device 102 can influence whether a user will grip the user device 102 such that one or both hands are covering an antenna, thereby causing signal degradation for the various radios of the user device 102.

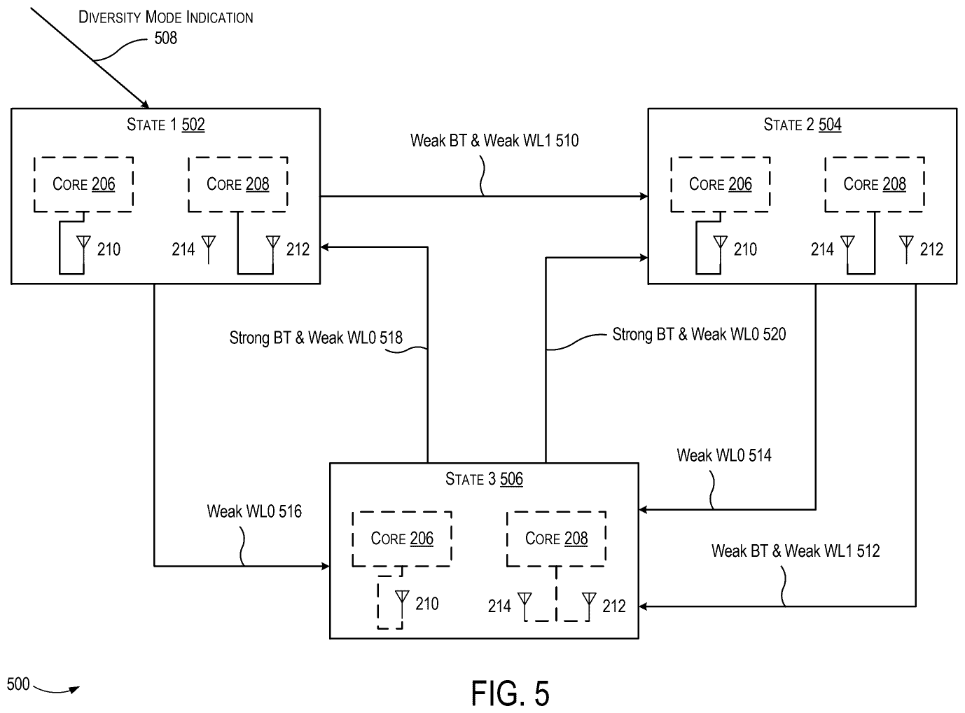

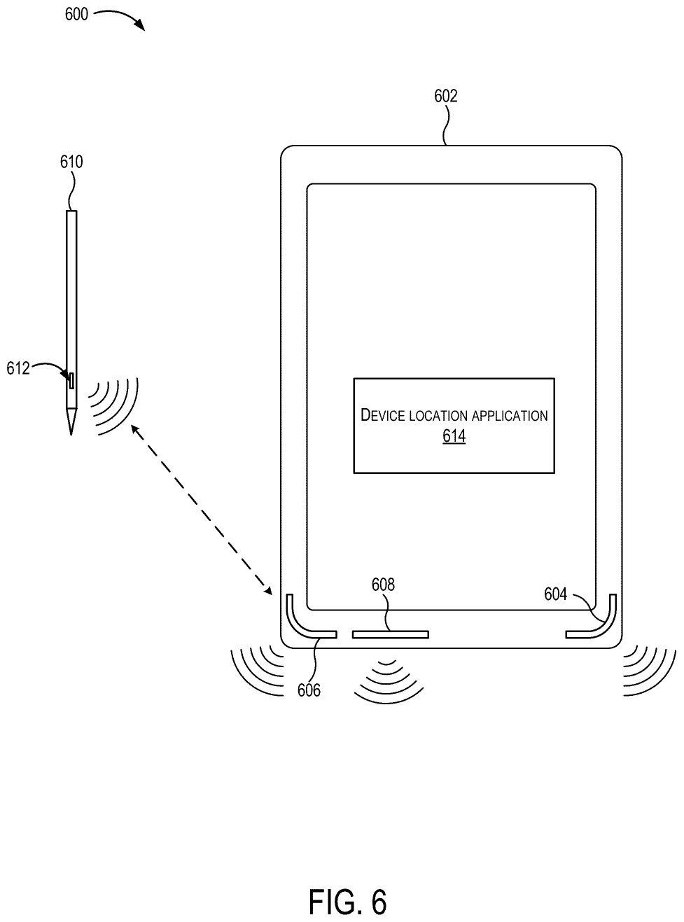

At block 122, the user device 102 can enter the diversity mode 106. Entering the diversity mode 106 can be in response to the user device 102 detecting that it is in a particular orientation (e.g., an inverted orientation). The diversity mode 106 can include a plurality of operating states (diversity mode states). Once the user device 102 is operating in the diversity mode 106, one or more diversity mode states of the diversity mode can be transitioned based on one or more measurements of signal strength at any/all of the plurality of antennas 104, including measurements of the signal strength for one or more of the radios configured to operate with the plurality of antennas 104. In some examples, the diversity mode 106 can include three states. A first diversity mode state can be the default state when the user device 102 enters the diversity mode. For example, the first diversity mode state can be characterized by the radios of the user device 102 being configured for hybrid operation using the two corner antennas of the plurality of antennas 104, while the second diversity mode state can be characterized by the radios being configured for hybrid operation using one of the corner antennas and the diversity antenna. A third diversity mode state can be characterized by the radios being configured for TDD operation using the best available antenna or antennas. The states of the diversity mode 106, including the thresholds for transitioning between each of the diversity mode states, are described in more detail below with respect to FIG. 5. In some embodiments, the diversity mode 106 can include a device locating state that is entered if the user device 102 executes a device location application. In the device locating state, the radio used for device location (e.g., Bluetooth) can be configured to operate using a specific antenna of the plurality of antennas 104 to improve the device locating capabilities. Additional details of the device locating mode are provided below with respect to FIG. 6.

At block 124, the user device 102 can measure a signal strength for one or more of the radios at one or more of the antennas of the plurality of antennas 104. A user device 102 may be held such that the hand 114 of the user covers, at least partially, one or more of the antennas of the plurality of antennas 104. As depicted in FIG. 1, the hand 114 can cover the corner antenna. The user device 102 can measure the signal strength 108 corresponding to a radio operating using the corner antenna. For example, the user device 102 can measure the signal strength 108 of the Wi-Fi radio when the corner antenna is in use. The user device 102 can also measure the signal strength of the Bluetooth radio at either or both corner antennas of the plurality of antennas 104. For example, the user device 102 can measure the signal strength 110 of the Bluetooth radio based on use of the other corner antenna.

At block 126, if the signal strength 108 of one radio (e.g., Wi-Fi) at the corner antenna falls below a signal strength threshold, the user device 102 can transition to a second diversity mode state. In some embodiments, it may be required that a second signal strength (e.g., signal strength 110) corresponding to another radio (e.g., Bluetooth) also falls below a second signal strength threshold for the user device 102 to transitions to the second diversity mode state, e.g., such that both the signal strength 108 and the second signal strength must fall below their respective signal strength thresholds. In the second diversity mode state, the user device 102 can configure one or more radios to operate in an improved state. For example, since the corner antenna is covered by the hand 114 of the user, thereby attenuating the signal strength 108, the second diversity mode state can include the Wi-Fi radio and the Bluetooth radio operating in the hybrid mode using the diversity antennas 118 and the second corner antenna 116 to provide the improved signal conditions.

FIG. 2 illustrates an example simplified architecture 200 of a radio controller 204 communicatively connected to a plurality of antennas of a user device 202, according to some embodiments. The user device 202 may be an example of user device 102 of FIG. 1. The user device 202 can include a first antenna 210, a second antenna 212, and a diversity antenna 214 in the plurality of antennas, which can be an example of the plurality of antennas 104 of FIG. 1.

The user device 202 can include the radio controller 204. The radio controller 204 can be implemented with one or more integrated circuit devices in conjunction with suitable software and/or firmware to operate one or more radios. For example, the radio controller can be configured to operate a Wi-Fi radio, a Bluetooth radio, and/or one or more radios using communication protocols such as Thread, Zigbee, and/or Matter. As used herein, the term “radio” refers to the combination of software and device hardware, including antennas and RF circuitry, that function to transmit and receive data via radio frequency wireless signals emitted from and/or received at the one or more antennas. Further, a “radio” can be characterized by a standard that defines a communication protocol and/or communication characteristics (e.g., signal power, carrier frequency, frequency bands, channels, data format, etc.).

The radio controller 204 can host two radio controller cores 206, 208. A first radio controller core 206 can be communicatively connected to the first antenna 210. A second radio controller core 208 can be communicatively connected to the second antenna 212. Continuing the particular example from FIG. 1, the radio controller 204 can be configured to operate a Wi-Fi radio (a first radio) and a Bluetooth radio (a second radio). First radio controller core 206 can be configured to drive the first antenna 210 for both the Wi-Fi radio, via link 216, and the Bluetooth radio, via link 218. Similarly, second radio controller core 208 can be configured to drive the second antenna 212 for the Wi-Fi radio via link 220 and for the Bluetooth radio via link 222. The radio controller 204 can also be configured to implement one or more antenna diversity policies for each radio to allow each radio to operate using the first antenna 210 and the second antenna 212, while reducing signal conflicts. For example, the Wi-Fi radio and the Bluetooth radio can be configured to operate over the first antenna 210 and the second antenna 212 in a hybrid mode so that transmission and/or reception of Wi-Fi signals and Bluetooth signals are coordinated between the first antenna 210 and the second antenna 212. One skilled in the art would recognize the application of conventional antenna diversity policies for operating multiple radios using two antennas.

In embodiments described herein, second radio controller core 208 can also be communicatively connected to the diversity antenna 214. Second radio controller core 208 can be configured to drive the diversity antenna 214 for either or both of the Wi-Fi radio via link 220 and the Bluetooth radio via link 222. The radio controller 204 can be configured to implement the diversity mode to select the diversity antenna 214 for the Wi-Fi radio and the Bluetooth radio to use for hybrid operation, e.g., instead of the second antenna 212. While in a diversity mode state allowing hybrid operation with the diversity antenna 214, the radio controller 204 can operate the Wi-Fi radio and the Bluetooth radio using the first antenna 210 and the diversity antenna 214, using the first antenna 210 and the second antenna 212, or any other such combination.

FIG. 3 illustrates an example user device 300 including a plurality of antennas positioned around a periphery of the user device 300, according to some embodiments. The user device 300 can be an example of other user devices described herein, including user device 102 of FIG. 1 and user device 202 of FIG. 2.

The plurality of antennas can include a first antenna 304, a second antenna 306, and a diversity antenna 308. Other implementations using one or more additional and/or different antennas also are possible. As depicted in FIG. 3, the first antenna 304 can be positioned near the corner of the chassis of the user device 300 while the second antenna 306 can be positioned near an adjacent corner of the chassis of the user device 300. The diversity antenna 308 can be positioned near an edge of the chassis of the user device 300, e.g., between the first antenna 304 and the second antenna 306. In some embodiments, the diversity antenna 308 can be positioned at other locations within the user device 300. For example, the diversity antenna 308 can be positioned at an edge opposite the first antenna 304 and the second antenna 306. In another example, the diversity antenna 308 can be positioned at another corner of the user device 300.

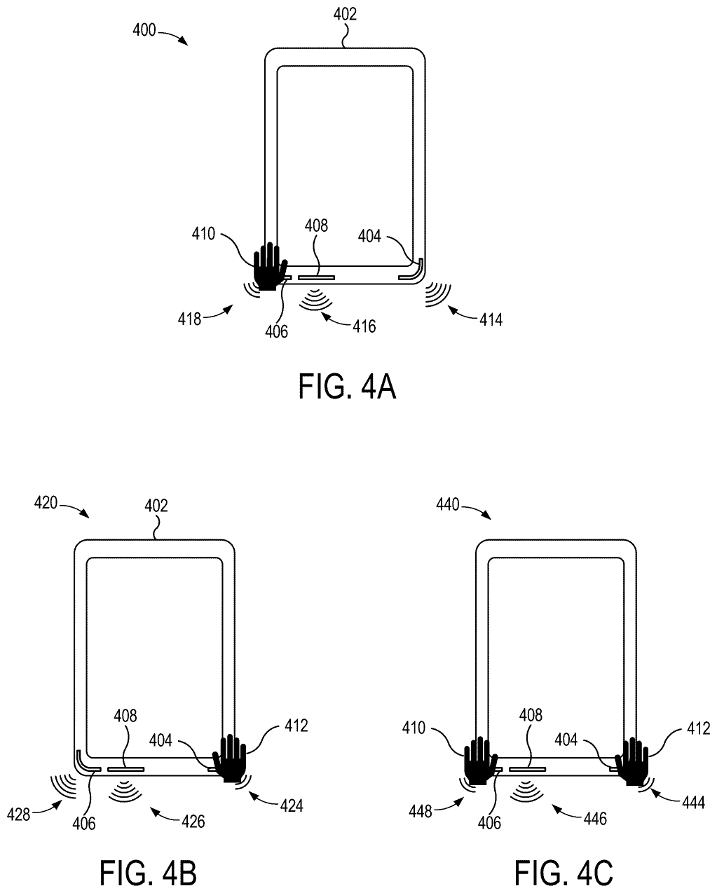

The locations of the first antenna 304, the second antenna 306, and the diversity antenna 308 shown in FIG. 3 can be at the “top” edge of the user device 300 when the user device 300 is positioned in a portrait orientation. Typically, when a user holds the user device 300 in the portrait orientation, the user's hand(s) will be near the bottom or side(s) of the user device 300 and away from the plurality of antennas. However, as described below with respect to FIG. 4, the user device 300 can also be inverted so that the plurality of antennas is near the “bottom” edge of the user device 300. In this inverted portrait orientation, the user is more likely to hold the user device 300 with one or both hands covering one or more of the corners of the user device corresponding to the first antenna 304 and the second antenna 306. As a result, one or more antennas may be at least partially occluded.

FIG. 4A illustrates an example user device 402 held in an inverted orientation 400 with a user's hand 410 covering a second antenna 406 of a plurality of antennas of the user device 402, according to some embodiments. The user device 402 may be an example of user device 300 described above with respect to FIG. 3, with the first antenna 404, the second antenna 406, and the diversity antenna 408 examples of first antenna 304, second antenna 306, and diversity antenna 308, respectively.

With the user's hand 410 covering the second antenna 406, a signal strength 418 may be attenuated compared to a signal strength for uncovered operation. By comparison, the signal strength 414 for signals transmitted or received at the first antenna 404 may be unattenuated since the first antenna 404 remains uncovered (e.g., the user holds user device 402 with one hand). Similarly, a signal strength 416 from the diversity antenna 408 may also be unattenuated (when the device is operating in a diversity mode state in which the diversity antenna 408 is selected for use with the radios). In some implementations, the signal strengths (e.g., signal strength 418) can be measured by the user device 402 as an RSSI. The ranges for a strong, unattenuated signal strength can depend on the radio. For example, a strong Wi-Fi RSSI can be greater than −55 dBm, a medium Wi-Fi RSSI can range from −66 dBm to −55 dBm, a weak Wi-Fi RSSI can range from −75 dBm to −66 dBm, and a very weak Wi-Fi RSSI can be below −75 dBm. For Bluetooth, a strong RSSI can be greater than or equal to −50 dBm while a weak RSSI can be less than −50 dBm. Weaker signals for each radio type can diminish the data throughput achievable by the radio. Therefore, when the user's hand 410 covers the second antenna 406, the signal strength 418 for Wi-Fi may be attenuated to below −66 dBm. For Bluetooth, the signal strength 418 may be attenuated to below −50 dBm. In other implementations, one or more other metrics can be used to assess signal strength, such as Reference Signal Received Power (RSRP), Signal to Interference plus Noise Ratio (SINR), packet error rate, block error rate, etc.

When the user device 402 is held in the inverted orientation 400, an improved operating state for two radios can include hybrid operation using the first antenna 404 and the diversity antenna 408. The radio controller of the user device 402 can configure the radios to select the diversity antenna 408 when performing their respective antenna diversity algorithms.

FIG. 4B illustrates the user device 402 of FIG. 4A held in an inverted orientation 420 with a user's hand 412 (or other blockage) at least partially covering a first antenna 404 of the plurality of antennas of the user device 402, according to some embodiments. When the user's hand 412 (or any other obstruction) covers the first antenna 404, the signal strength 424 from the antenna (e.g., RSSI for either Wi-Fi or Bluetooth radios) can be attenuated. By comparison, the signal strength 428 from the second antenna 406 and the signal strength 426 from the diversity antenna 408 may be unattenuated.

FIG. 4C illustrates the user device of FIG. 4A held in an inverted orientation 440 with both the user's hands 410, 412 covering both the first antenna 404 and the second antenna 406 of the user device 402, according to some embodiments. In this case, the user covers both the first antenna 404 and the second antenna 406, resulting in attenuation of the signal strength 444 and signal strength 448, respectively. The signal strength 446 from the diversity antenna 408 may be unattenuated.

In some embodiments, a weak signal strength at the first antenna 404 (e.g., signal strength 424, signal strength 444) can indicate that an improved operating mode for the radios of the user device 402 is TDD rather than hybrid operation. When the user device 402 is held in inverted orientation 420 or inverted orientation 440, because the first antenna 404 is at least partially covered, the diversity mode state using TDD can be selected, as described more fully below with respect to FIG. 5.

FIG. 5 illustrates a state diagram 500 of the plurality of diversity mode states for configuring the radios of the user device using a plurality of antennas, according to some embodiments. The user device can be an example of the user device 202 of FIG. 2, with the plurality of antennas including first antenna 210, second antenna 212, and diversity antenna 214. As depicted in the state diagram 500, a radio controller (e.g., radio controller 204 of FIG. 2) can include first radio controller 206 and second radio controller core 208 communicatively connected to the plurality of antennas depending on the current diversity mode state of the diversity mode. The user device can operate a Bluetooth radio and a Wi-Fi radio using the radio controller and the radio controller cores 206, 208. Each radio can transmit and receive on multiple antennas of the plurality of antennas according to an antenna diversity algorithm. Therefore, each radio controller core can manage the transmission and reception of signals from the associated antenna(s) communicatively connected to the radio controller core. For example, the first radio controller core 206 can manage both Wi-Fi signals and Bluetooth signals at the first antenna 210, while the second radio controller core 208 can manage both Wi-Fi signals and Bluetooth signals at the second antenna 208 and/or the diversity antenna 214. For clarity in FIG. 5, Wi-Fi radio signals handled by the first radio controller core 206 are denoted “WL0,” while Wi-Fi radio signals handled by the second radio controller core 208 are denoted “WL1.”

The user device can enter the diversity mode and a first diversity mode state 502 (“State 1”) in response to receiving a diversity mode indication 508. As described above, the diversity mode indication 508 can include detecting that the user device has a particular physical configuration including a particular orientation, such as an inverted portrait orientation. The diversity mode indication 508 can also include detecting that the user device is operating in a clamshell mode. The first diversity mode state 502 may be the default diversity mode state of the plurality of diversity mode states so that each time the user device enters the diversity mode, the first diversity mode state 502 is the operating state for the radios of the user device. In some embodiments, another of the diversity modes states described herein can be configured to be the default state of the diversity mode.

When in the first diversity mode state 502, the user device can configure the radio controller so that signals for the radios (Bluetooth and Wi-Fi) managed by the second radio controller core 208 use the second antenna 212. For example, the Bluetooth and Wi-Fi radios can both operate using the first antenna 210 via first radio controller core 206 and the second antenna 212 via second radio controller core 208 in the hybrid mode, in which the selection of each antenna is determined using each radio's antenna diversity algorithm. The first diversity mode state 502 can exclude the diversity antenna 214 from selection by the radios.

While in the first diversity mode state 502, the user device can measure one or more signals for the radios at each of the first antenna 210 and the second antenna 212. Based on the measured signal strength(s), the user device can transition from the first diversity mode state 502 to either the second diversity mode state 504 or the third diversity mode state 506. In one example, the user device can measure the signal strength (e.g., RSSI) of the Bluetooth radio at one or both of the first antenna 210 and the second antenna 212. The user device can also measure the signal strength (e.g., RSSI) of the Wi-Fi radio at the second antenna 212 (e.g., WL1, since the second radio controller core 208 is configured to use the second antenna 212 while in the first diversity mode state 502). If both the Bluetooth signal strength and the WL1 signal strength fall below respective signal strength thresholds (e.g., are “weak”), then the user device can transition to the second diversity mode state 504, as denoted by decision 510. As described briefly above, the signal strength threshold characterizing a “weak” signal can depend on the type of radio. As a non-limiting example, a weak Bluetooth signal can be characterized by a signal strength threshold of −50 dBm, while a weak Wi-Fi signal can be characterized by a signal strength threshold of −66 dBm. Other signal strength thresholds can be used depending on the desired radio performance of the user device. Using these exemplary signal strength thresholds, decision 510 can include determining that the BT signal strength falls below −50 dBm at either the first antenna 210 or the second antenna 212 and the WL1 signal strength falls below −66 dBm. Detecting the WL1 signal strength below a signal strength threshold can be indicative of the user covering the second antenna 212 with a hand while holding the user device in the inverted orientation.

Additionally, while in the first diversity mode state 502, the user device can measure the signal strength of the Wi-Fi radio at the first antenna 210 (e.g., WL0, since the first radio controller core 206 is configured to use the first antennas 210). If WL0 falls below a signal strength threshold (e.g., −66 dBm), then the user device can transition from the first diversity mode state 502 to the third diversity mode state 506, as denoted by decision 516. The configuration of the radios of the user device while in the third diversity mode state 506 is described below. A weak WL0 signal can be indicative of the user covering the first antenna with a hand while holding the user device in the inverted orientation.

When in the second diversity mode state 504, the user device can configure the radio controller so that signals for the radios (Bluetooth and Wi-Fi) managed by the second radio controller core 208 use the diversity antenna 214. For example, the Bluetooth and Wi-Fi radios can both operate using the first antenna 210 via first radio controller core 206 and the diversity antenna 214 via second radio controller core 208 in the hybrid mode, in which the selection of each antenna is determined using each radio's antenna diversity algorithm. The second diversity mode state 504 can exclude the second antenna 212 from selection by the radios.

While in the second diversity mode state 504, the user device can measure one or more signals for the radios at each of the first antenna 210 and the diversity antenna 214. Based on the measured signal strength(s), the user device can transition from the second diversity mode state 504 to the third diversity mode state 506. Continuing the example above, the user device can again measure the signal strength of the Bluetooth radio at one or both of the first antenna 210 and the diversity antenna 214 and also measure the signal strength of the Wi-Fi radio at the diversity antenna 214 (WL1 again, since the second radio controller core 208 is configured to use the diversity antenna 214 while in the second diversity mode state 504). If both the Bluetooth signal strength and the WL1 signal strength again fall below respective signal strength thresholds (e.g., are “weak”), then the user device can transition to the third diversity mode state 506, as denoted by decision 512.

Additionally, while in the second diversity mode state 504, the user device can measure the signal strength of the Wi-Fi radio at the first antenna 210. If WL0 falls below a signal strength threshold (e.g., −66 dBm), then the user device can transition from the second diversity mode state 504 to the third diversity mode state 506, as denoted by decision 514.

When in the third diversity mode state 506, the user device can configure the radio controller so that signals for the radios (Bluetooth and Wi-Fi) managed by first radio controller core 206 and the second radio controller core 208 operate using TDD. The selection of the antenna can be performed by the antenna diversity algorithm for each radio.

Because TDD operation can reduce the throughput for each radio, it can be desirable to return to the hybrid mode of the first diversity mode state 502 or the second diversity mode state 504 as signal strength improves. In some implementations, a return to hybrid mode can be triggered based on the signal strength improvement of at least one radio. While in the third diversity mode state 506, the user device can continue to measure the signal strengths for the radios. For example, the user device can measure the BT signal strength at either the second antenna 212 or the diversity antenna 214 and can measure the WL0 signal strength at the first antennas 210. If the WL0 signal strength is above a signal strength threshold (e.g., −66 dBm) and the BT signal strength at the second antenna 212 is above a signal strength threshold (e.g., −50 dBm), the user device can transition to the first diversity mode state 502 and configure the second radio controller core 208 to use the second antenna 212 in the hybrid mode for both the Wi-Fi and Bluetooth radios, as denoted by decision 518. If the WL0 signal strength is above the signal strength threshold (e.g., −66 dBm) and the BT signal strength at the diversity antenna 214 is above the signal strength threshold (e.g., −50 dBm), the user device can transition to the second diversity mode state 504 and configure the second radio controller core 208 to use the diversity antenna 214 in the hybrid mode for both the Wi-Fi and Bluetooth radios, as denoted by decision 520.

When in any of the diversity mode states of the plurality of diversity mode states, the user device can measure the signal strengths at various intervals. For example, the signal strength for each radio can be determined every 50 ms, 100 ms, 200 ms, etc. As another example, the signal strength for a radio can be determined based on an event, e.g., at the completion of each connection event. Measuring the signal strength for a first radio (e.g., Bluetooth) can be performed on an interval different from the interval for measuring the signal strength for a second radio (e.g., Wi-Fi). One skilled in the art would recognize many variations for determining the signal strength of various radios.

While in any of the first diversity mode state 502, the second diversity mode state 504, or the third diversity mode state 506, the user device can exit the diversity mode upon receiving an indication (not shown in FIG. 5) that the user device has left the particular orientation (e.g., the inverted orientation) corresponding to the diversity mode indication 508. For example, the user device can be rotated to a landscape orientation or a portrait orientation in which the user's hand position is unlikely to cover the plurality of antennas. Additionally, while in any of the plurality of diversity mode states, the user device can enter a device locating state if a device location application is executed on the user device. While in the device locating state, one of the radios can be configured to act as a device locating radio using one or more of the plurality of antennas to improve the device locating capability of the radio. The antenna(s) can be selected based on the measured signal strength of the device locating radio (e.g., Bluetooth) so that the antenna providing the highest signal strength is used when in the device locating state.

FIG. 6 illustrates an example user device 602 held in an inverted orientation 600 and executing a device location application 614 when operating in one of a plurality of diversity mode states, according to some embodiments. The user device 602 can be an example of user device 300 of FIG. 3 and operating in one of the plurality of diversity mode states described above with respect to FIG. 5.

The user device 602 can determine that the device location application 614 is executing. For example, a user of the user device 602 can start the device location application 614 to assist in locating a peripheral device (e.g., stylus 610) that can communicate with the user device 602 via a radio (e.g., Bluetooth). The device location application 614 can be configured to transmit and receive signals using the radio to determine a range, direction, and/or location of the peripheral device with respect to the user device 602. While in the diversity mode, the user device 602 may have configured its radios to operate using particular antennas of the plurality of antennas. For use with the device location application 614, it can be desirable to select the antenna producing a higher signal strength for the device locating radio rather than the selection indicated by the diversity mode state that improves the simultaneous performance of both the Wi-Fi and Bluetooth radio.

As depicted in FIG. 6, when the user device 602 determines that the device location application 614 is executing, the user device 602 can enter a device locating state. While in the device locating state, the user device 602 can measure a signal strength for a device locating radio (e.g., the Bluetooth radio) at one of a first antenna 604, a second antenna 606, and a diversity antenna 608. The signal strength may be relative to signals received from the stylus 610 using the device locating radio. For example, the stylus 610 can communicate using Bluetooth via antenna 612. The user device 602 can determine that the signal strength for the Bluetooth radio is strongest at second antenna 606 and select second antenna 606 for use while in the device locating state.

When the device location application 614 terminates, the user device 602 can return to the diversity mode state of the plurality of diversity mode states that the user device 602 was in when it entered the device locating state.

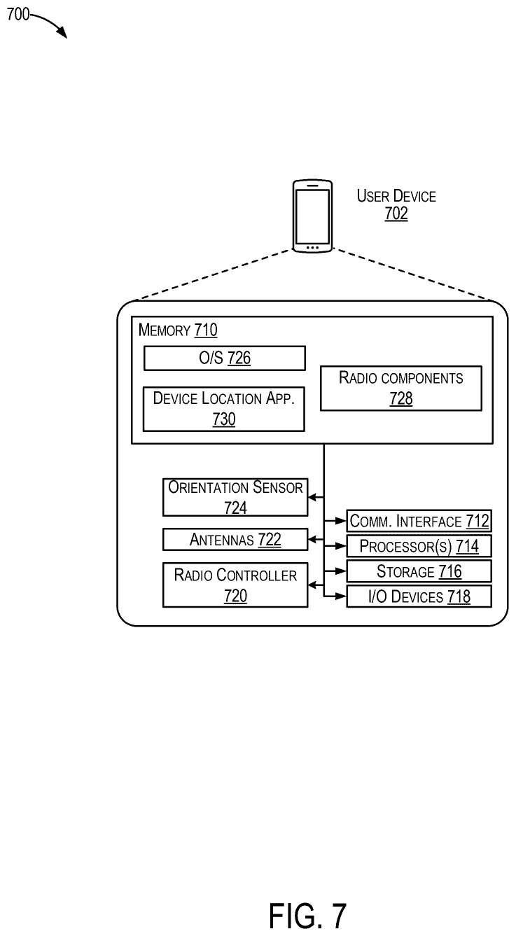

FIG. 7 illustrates an example architecture 700 of a user device 702 that can implement techniques for operating in a plurality of diversity mode states, according to some embodiments. The user device 702 may be an example of other user devices described herein, including user device 102 of FIG. 1 and user device 300 of FIG. 3.

As described herein, the user device 702 can have at least one memory 710, a communications interface 712, one or more processing units (or processor(s)) 714, a storage 716, a radio controller 720, a plurality of antennas 722, an orientation sensor 724, and one or more input/output (“I/O”) device(s) 718. The processor(s) 714 may be implemented as appropriate in hardware, computer-executable instructions, firmware or combinations thereof. Computer-executable instruction or firmware implementations of the processor(s) 714 may include computer-executable or machine executable instructions written in any suitable programming language to perform the various functions described. The I/O device(s) 718 can include displays, monitors, touch screens, mouse, keyboard, or other I/O device. The radio controller 720 can be an example of the radio controller 204 of FIG. 2 configured to implement one or more radios using the plurality of antennas 722 as described herein. The plurality of antennas 722 can include a first antenna (e.g., first antenna 210 of FIG. 2), a second antenna (e.g., second antenna 212 of FIG. 2), and a diversity antenna (e.g., diversity antenna 214 of FIG. 2). The radio controller 720 can be configured to implement the diversity mode for antenna coexistence with the first antenna, second antenna, and the diversity antenna as described herein.

The memory 710 may store program instructions that are loadable and executable on the processor(s) 714, as well as data generated during the execution of these programs, including data transmitted and received using one or more radios. Depending on the configuration and type of user device 702, the memory 710 may be volatile (such as random access memory (“RAM”)) or non-volatile (such as read-only memory (“ROM”), flash memory, etc.). In some implementations, the memory 710 may include multiple different types of memory, such as static random access memory (“SRAM”), dynamic random access memory (“DRAM”) or ROM. The user device 702 may also include additional storage 716, such as either removable storage or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some embodiments, the storage 716 may be utilized to store data contents received from one or more other devices (e.g., devices connected to via a Wi-Fi radio).

The memory 710 may include an operating system (O/S) 726 and one or more application programs, software components, or services for implementing the features disclosed herein, including radio components 728 and a device location application 730. The radio components 728 can include the software components for operating one or more radios in conjunction with the radio controller 720. For example, the radio components 728 can include software objects for handling Wi-Fi interfaces. In some examples, the radio components 728 may be part of the O/S 726. The device location application 730 may be configured to determine the location, distance, and/or position of a peripheral device (e.g., stylus 610 of FIG. 6) using one of the radios of the user device 702. For example, the device location application 730 can use a Bluetooth radio using one of the plurality of antennas 722 having a higher signal strength when operating in a device locating state.

The user device 702 may also contain a communications interface 712 that allows the user device 702 to communicate with a stored database, another computing device or server, additional user device(s). The communications interface 712 can operate in conjunction with the radio controller 720 and the plurality of antennas 722 to operate the radios. The user device 702 may also include I/O device(s) 718, such as for enabling connection with a keyboard, a mouse, a pen, a voice input device, a touch input device, a display, speakers, a printer, etc.

FIG. 8 illustrates an example process 800 for configuring a plurality of radios to operate with one or more of a plurality of antennas in one or more of a plurality of diversity mode states, according to some embodiments. The process 800 may be performed by a user device, including, for example, user device 102 of FIG. 1 or another user device described herein. Some of the operations described with respect to process 800 may be similar to operations described above with respect to process 100 of FIG. 1.

Process 800 may begin at block 802 when a user device receives an indication that the user device has a physical configuration relative to the plurality of antennas positioned within the user device. The physical configuration can include a particular orientation of the user device with respect to the plurality of antennas. For example, the plurality of antennas can include a first antenna positioned within the chassis of the user device near a corner and a second antenna positioned within the chassis of the user device near an adjacent corner to the first antenna. The plurality of antennas can also include a diversity antenna positioned within the chassis of the user device adjacent to an edge of the user device between the first antenna and the second antenna, as depicted in FIG. 3. The edge and two adjacent corners can define a “top” edge of the user device when held in a portrait orientation. When the user device is inverted so that the edge with the plurality of antennas is at the “bottom” of the user device, a position sensor within the user device can determine that the user device is held in an inverted orientation and provide the indication of the orientation defined with respect to the plurality of antennas. The physical configuration can also include a clamshell configuration (also referred to as clamshell mode) characterized by a device cover positioned over at least a portion of the user device. For example, the user device can include a cover that wraps around the front and back sides of the user device, including covering a portion of the user device chassis along the edge having the first antenna, second antenna, and diversity antenna. If the user device is connected to a peripheral device (e.g., an external monitor, an external keyboard) while the cover is in place, the user device can detect that the user device is operating in clamshell mode.

At block 804, the user device can configure a plurality of radios to operate in a first diversity mode state of a plurality of diversity mode states. Configuring the plurality of radios can occur in response to the indication that the device has a physical configuration including a particular orientation (e.g., the inverted portrait orientation) when it is more likely that a user grips the user device with their hands covering one or more of the plurality of antennas. The plurality of radios can include a Bluetooth radio (in the 2.4 GHz band) and one or more Wi-Fi radios (in the 2.4 GHz band, the 5 GHz band, and/or the 6 GHz band) to support wireless communication between the user device and, for example, peripheral devices, a wireless network, and the like. The plurality of radios can be operable to transmit and receive using one or more of the plurality of antennas. For example, the plurality of radios can be operated with a radio controller that can drive the first antenna, the second antenna, and the diversity antenna using one or more radio controller cores. The radio controller can be configured to operate an antenna diversity algorithm for each radio. In some embodiments, configuring the plurality of radios to operate in the first diversity mode state comprises configuring the plurality of radios to operate using a first antenna and a second antenna of the plurality of antennas. For example, the plurality of radios can include the Bluetooth radio and a Wi-Fi radio configured to use the first antenna and the second antennas according to respective antenna diversity algorithms.

At block 806, the user device can determine (e.g., measure) a signal strength for a first radio of the plurality of radios while in the first diversity mode state. The first radio can be a Wi-Fi radio. The signal strength may be measured with respect to one or more of the plurality of antennas. For example, the user device can measure the RSSI for the Wi-Fi radio at the second antenna.

At block 808, the user device can determine whether the signal strength of the first radio falls below a signal strength threshold corresponding to the first radio. For example, if the first radio is a Wi-Fi radio, the signal strength threshold may define a “weak” signal (e.g., −66 dBm). If the RSSI for the Wi-Fi radio at the second antenna falls below −66 dBm, then the Wi-Fi radio may be weak and the second antenna may be covered by the user's hand. As used herein, the term “falls below” can include a measured quantity being less than a threshold quantity and should not be read as limited to cases where a quantity begins above a threshold quantity and moves below the threshold quantity during subsequent measurements.

At block 810, if the signal strength falls below the signal strength threshold, the user device can configure the plurality of radios to operate in a second diversity mode state of the plurality of diversity mode states. In some embodiments, configuring the plurality of radios to operate in the second diversity mode state can include configuring the plurality of radios to operate using a first antenna and a diversity antenna of the plurality of antennas. For example, if the user device determines that the Wi-Fi signal is “weak” at the second antenna, the user device can configure the radio controller to select the diversity antenna instead of the second antenna when operating the plurality of radios.

In some embodiments, the user device can configure a plurality of radios to operate in a first diversity mode state of a plurality of diversity mode states. The plurality of radios can be operable to communicate using one or more of a plurality of antennas of the user device. While in the first diversity mode state, the user device can determine whether a first radio signal strength of a first radio of the plurality of radios is below a first radio signal strength threshold and, in accordance with the first radio signal strength being below the first radio signal strength threshold, configure the plurality of radios to operate in a second diversity mode state of the plurality of diversity mode states.

In some embodiments, the signal strength can be a first radio signal strength (e.g., Wi-Fi at the second antenna, WL1). Similarly, the signal strength threshold can be a first radio signal strength threshold that corresponds to the first radio (e.g., a signal strength threshold defining a “weak” Wi-Fi signal). While in the first diversity mode state, the user device can measure a second radio signal strength for a second radio of the plurality of radios. For example, the second radio may be a Bluetooth radio. The second radio signal strength can be determined at one or more of the plurality of antennas. For example, the second radio signal strength can be the Bluetooth signal strength measured at either the first antenna or the second antenna. The user device can determine whether the second radio signal strength falls below a second radio signal strength threshold corresponding to the second radio. For example, a second radio signal strength threshold that defines a “weak” Bluetooth signal may be −50 dBm. If both the first radio signal strength falls below the first radio signal strength threshold (e.g., weak WL1) and the second radio signal strength falls below the second radio signal strength threshold (e.g., weak BT), the user device can configure the plurality of radios to operate in the second diversity mode state.

In some embodiments, the user device can measure the first radio signal strength and the second radio signal strength while in the second diversity mode state. For example, after the user device transitions to the second diversity mode state, the user device can re-measure the signal strengths of the Wi-Fi radio at the second antenna and the Bluetooth antenna at either the first antenna or the second antenna. The user device can then determine whether the first radio signal strength falls below the first radio signal strength threshold and whether the second radio signal strength falls below the second radio signal strength threshold. If the first radio signal strength falls below the first radio signal strength threshold and the second radio signal strength falls below the second radio signal strength threshold, the user device can configure the plurality of radios to operate in a third diversity mode state of the plurality of diversity mode states. In some embodiments, configuring the plurality of radios to operate in a third diversity mode state can include configuring the plurality of radios to operate using time division duplex over one or more of the plurality of antennas.

In some embodiments, while in the second diversity mode state, the user device can measure the first radio signal strength of the first radio of the plurality of radios. For example, the first radio signal strength can be the signal strength of the Wi-Fi radio at the first antenna. The user device can determine whether the first radio signal strength falls below the first radio signal strength threshold corresponding to the first radio. For example, the user device can determine that the RSSI of the Wi-Fi radio at the first antenna (WL0) is weak (e.g., below −66 dBm). If the first radio signal strength falls below the first radio signal strength threshold, the user device can configure the plurality of radios to operate in a third diversity mode state.

In some embodiments, while in the third diversity mode state, the user device can measure the first radio signal strength of the first radio (e.g., Wi-Fi radio) and measure a second radio signal strength for the second radio (e.g., Bluetooth radio) of the plurality of radios. The second radio signal strength can correspond to the second antenna of the plurality of antennas. For example, the user device can measure the RSSI of the Bluetooth radio at the second antenna. The user device can determine whether the first radio signal strength exceeds the first radio signal strength threshold and whether the second radio signal strength exceeds the second radio signal strength threshold corresponding to the second radio. For example, if the RSSI of the Bluetooth radio at the second antenna is greater than or equal to −50 dBm, then the Bluetooth signal at the second antenna may be strong. Similarly, if the RSSI of the Wi-Fi radio at the first antenna is greater than or equal to −66 dBm, then the Wi-Fi signal at the first antenna (WL0) may be strong. If the first radio signal strength exceeds the first radio signal strength threshold and the second radio signal strength exceeds the second radio signal strength threshold, the user device can configure the plurality of radios to operate in the first diversity mode state. For example, since the Bluetooth signal is strong at the second antenna, the user device can transition from the third diversity mode state to the first diversity mode state configured to use the first antenna and the second antenna, as opposed to transitioning to the second diversity mode state configured to use the first antenna and the diversity antenna.

In some embodiments, while in the third diversity mode state, the user device can measure the first radio signal strength of the first radio (e.g., Wi-Fi radio) and measure a second radio signal strength for the second radio (e.g., Bluetooth radio) of the plurality of radios. The second radio signal strength can correspond to the diversity antenna of the plurality of antennas. For example, the user device can measure the RSSI of the Bluetooth radio at the diversity antenna. The user device can determine whether the first radio signal strength exceeds the first radio signal strength threshold and whether the second radio signal strength exceeds the second radio signal strength threshold corresponding to the second radio. For example, if the RSSI of the Bluetooth radio at the diversity antenna is greater than or equal to −50 dBm, then the Bluetooth signal at the diversity antenna may be strong. If the first radio signal strength exceeds the first radio signal strength threshold and the second radio signal strength exceeds the second radio signal strength threshold, the user device can configure the plurality of radios to operate in the second diversity mode state. For example, since the Bluetooth signal is strong at the diversity antenna, the user device can transition from the third diversity mode state to the second diversity mode state configured to use the first antenna and the diversity antenna, as opposed to transitioning to the first diversity mode state configured to use the first antenna and the second antenna.

In some embodiments, the user device can receive a second indication that a device location application is active at the user device. For example, a user using the user device can open the device location application to assist in finding a peripheral device (e.g., stylus 610 of FIG. 6) that can communicate with the user device using one of the plurality of the radios (e.g., the Bluetooth radio). In response to the second indication, the user device can configure a second radio (e.g., the Bluetooth radio) of the plurality of radios to operate in a device locating state. When in the device locating state, the user device can configure the second radio to transmit and receive using one of a first antenna or a second antenna of the plurality of antennas. For example, the user device can measure the RSSI of the Bluetooth radio at both the first antenna and the second antenna. Depending on which antenna the Bluetooth radio signal is strongest, the user device can select that antenna for use for the Bluetooth radio while in the device locating state. In some embodiments, the user device can also measure the signal strength of the Bluetooth radio at the diversity antenna and select the diversity antenna for use by the Bluetooth radio in the device locating state.

Illustrative methods and systems for dynamic antenna diversity policies are described above. Some or all of these systems and methods may, but need not, be implemented at least partially by architectures such as those shown at least in FIG. 6. Further, in the foregoing description, various non-limiting examples were described. For purposes of explanation, specific configurations and details are set forth in order to provide a thorough understanding of the examples. However, it should also be apparent to one skilled in the art that the examples may be practiced without the specific details. Furthermore, well-known features were sometimes omitted or simplified in order not to obscure the example being described.

The various examples further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C#or C++, or any scripting language, such as Perl, Python or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid- state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non- removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

As described above, one aspect of the present technology is the gathering and use of data to improve the functioning of device radios in a wireless communication ecosystem. The present disclosure contemplates that in some instances, this gathered data may include personally identifiable information (PII) data that uniquely identifies or can be used to contact or locate a specific person. Such personal information data can include demographic data, location-based data (e.g., GPS coordinates), telephone numbers, email addresses, Twitter ID's, home addresses, or any other identifying or personal information.

The present disclosure recognizes that the use of such personal information data, in the present technology, can be used to the benefit of users. For example, the personal information data can be used to obtain access to an application for locating peripheral devices associated with a user, user account, or a user device.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of services related to tracking a user's location (e.g., via the user's mobile device), the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

All references, including publications, patent applications, and patents, cited herein are hereby incorporated by reference to the same extent as if each reference were individually and specifically indicated to be incorporated by reference and were set forth in its entirety herein.

What is claimed is:

1. A method performed by a user device, the method comprising:
configuring a plurality of radios of the user device to operate in a first diversity mode state of a plurality of diversity mode states, the plurality of radios operable to communicate using one or more of a plurality of antennas; and
while in the first diversity mode state:
determining whether a first radio signal strength of a first radio of the plurality of radios is below a first radio signal strength threshold; and
in accordance with the first radio signal strength being below the first radio signal strength threshold, configuring the plurality of radios to operate in a second diversity mode state of the plurality of diversity mode states.

2. The method of claim 1, further comprising, while in the first diversity mode state:
determining whether a second radio signal strength falls below a second radio signal strength threshold; and
in accordance with the first radio signal strength being below the first radio signal strength threshold and the second radio signal strength being below the second radio signal strength threshold, configuring the plurality of radios to operate in the secsond diversity mode state.

3. The method of claim 2, further comprising, while in the second diversity mode state:
determining whether the first radio signal strength is below the first radio signal strength threshold;
determining whether the second radio signal strength is below the second radio signal strength threshold; and
in accordance with the first radio signal strength being below the first radio signal strength threshold and the second radio signal strength being below the second radio signal strength threshold, configuring the plurality of radios to operate in a third diversity mode state of the plurality of diversity mode states.

4. The method claim 1, further comprising, while in the second diversity mode state:
determining whether the first radio signal strength is below the first radio signal strength threshold; and
in accordance with the first radio signal strength being below the first radio signal strength threshold, configuring the plurality of radios to operate in a third diversity mode state.

5. The method of claim 4, further comprising, while in the third diversity mode state:
determining whether the first radio signal strength exceeds the first radio signal strength threshold;
determining whether a second radio signal strength, corresponding to a second antenna of the plurality of antennas, exceeds a second radio signal strength threshold; and
in accordance with the first radio signal strength exceeding the first radio signal strength threshold and the second radio signal strength exceeding the second radio signal strength threshold, configuring the plurality of radios to operate in the first diversity mode state.

6. The method of claim 4, further comprising, while in the third diversity mode state:
determining whether the first radio signal strength exceeds the first radio signal strength threshold;
determining whether a second radio signal strength, corresponding to a diversity antenna of the plurality of antennas, exceeds a second radio signal strength threshold; and
in accordance with the first radio signal strength exceeding the first radio signal strength threshold and the second radio signal strength exceeding the second radio signal strength threshold, configuring the plurality of radios to operate in the second diversity mode state.

7. The method of claim 1, wherein configuring the plurality of radios to operate in the first diversity mode state comprises configuring the plurality of radios to operate using a first antenna and a second antenna of the plurality of antennas.

8. The method of claim 1, wherein configuring the plurality of radios to operate in the second diversity mode state comprises configuring the plurality of radios to operate using a first antenna and a diversity antenna of the plurality of antennas.

9. A user device, comprising:
a radio controller configured to control a plurality of radios;
a plurality of antennas communicatively connected to the radio controller;
one or more processors; and
one or more memories storing computer-executable instructions that, when executed by the one or more processors, cause the user device to:
configure the plurality of radios of the user device to operate in a first diversity mode state of a plurality of diversity mode states, the plurality of radios operable to communicate using one or more of the plurality of antennas; and
while in the first diversity mode state:
determine whether a first radio signal strength of a first radio of the plurality of radios is below a first radio signal strength threshold; and
in accordance with the first radio signal strength being below the first radio signal strength threshold, configure the plurality of radios to operate in a second diversity mode state of the plurality of diversity mode states.

10. The user device of claim 9, wherein the radio controller comprises a first radio controller core and a second radio controller core.

11. The user device of claim 10, wherein the first radio controller core is communicatively connected to a first antenna of the plurality of antennas.

12. The user device of claim 10, wherein the second radio controller core is communicatively connected to (i) a second antenna and (ii) a diversity antenna of the plurality of antennas.

13. The user device of claim 9, wherein the one or more memories store additional instructions that, when executed by the one or more processors, cause the user device to further, while in the first diversity mode state:
determine whether a second radio signal strength falls below a second radio signal strength threshold; and
in accordance with the first radio signal strength being below the first radio signal strength threshold and the second radio signal strength being below the second radio signal strength threshold, configure the plurality of radios to operate in the second diversity mode state.

14. The user device of claim 13, wherein the one or more memories store additional instructions that, when executed by the one or more processors, cause the user device to further, while in the second diversity mode state:
determine whether the first radio signal strength is below the first radio signal strength threshold;
determine whether the second radio signal strength is below the second radio signal strength threshold; and
in accordance with the first radio signal strength being below the first radio signal strength threshold and the second radio signal strength being below the second radio signal strength threshold, configure the plurality of radios to operate in a third diversity mode state of the plurality of diversity mode states.

15. The user device of claim 9, wherein configuring the plurality of radios to operate in the first diversity mode state comprises configuring the plurality of radios to operate using a first antenna and a second antenna of the plurality of antennas.

16. The user device of claim 9, wherein configuring the plurality of radios to operate in the second diversity mode state comprises configuring the plurality of radios to operate using a first antenna and a diversity antenna of the plurality of antennas.

17. One or more non-transitory computer-readable media storing computer-executable instructions that, when executed by one or more processors of a user device, cause the user device to at least:
configure a plurality of radios of the user device to operate in a first diversity mode state of a plurality of diversity mode states, the plurality of radios operable to communicate using one or more of a plurality of antennas; and
while in the first diversity mode state:
determine whether a first radio signal strength of a first radio of the plurality of radios is below a first radio signal strength threshold; and
in accordance with the first radio signal strength being below the first radio signal strength threshold, configure the plurality of radios to operate in a second diversity mode state of the plurality of diversity mode states.

18. The one or more non-transitory computer-readable media of claim 17, wherein the one or more memories store additional instructions that, when executed by the one or more processors, cause the user device to further, while in the second diversity mode state:
determining whether the first radio signal strength is below the first radio signal strength threshold; and
in accordance with the first radio signal strength being below the first radio signal strength threshold, configuring the plurality of radios to operate in a third diversity mode state.

19. The one or more non-transitory computer-readable media of claim 18, wherein the one or more memories store additional instructions that, when executed by the one or more processors, cause the user device to further, while in the third diversity mode state:
determine whether the first radio signal strength exceeds the first radio signal strength threshold;
determine whether a second radio signal strength, corresponding to a second antenna of the plurality of antennas, exceeds a second radio signal strength threshold; and
in accordance with the first radio signal strength exceeding the first radio signal strength threshold and the second radio signal strength exceeding the second radio signal strength threshold, configure the plurality of radios to operate in the first diversity mode state.

20. The one or more non-transitory computer-readable media of claim 18, wherein the one or more memories store additional instructions that, when executed by the one or more processors, cause the user device to further, while in the third diversity mode state:
determine whether the first radio signal strength exceeds the first radio signal strength threshold;
determine whether a second radio signal strength, corresponding to a diversity antenna of the plurality of antennas, exceeds a second radio signal strength threshold; and
in accordance with the first radio signal strength exceeding the first radio signal strength threshold and the second radio signal strength exceeding the second radio signal strength threshold, configure the plurality of radios to operate in the second diversity mode state.
